(19) United States
(12) Patent Application Publication
(10) Pub. No.: US 2016/0007407 A1
(43) Pub. Date: Jan. 7, 2016

(54) METHOD AND DEVICES FOR RELEASING A CHANNEL USING A VARIABLE EXPIRATION TIME

(71) Applicant: TELEFONAKTIEBOLAGET L M ERICSSON (PUBL), Stockholm (SE)

(72) Inventors: Jan Christoffersson, Luleå (SE); Min Wang, Luleå (SE); Edgar Ramos, Espoo (FI)

(73) Assignee: TELEFONAKTIEBOLAGET L M ERICSSON (publ), Stockholm (SE)

(21) Appl. No.: 14/770,491

(22) PCT Filed: Feb. 26, 2013
(86) PCT No.: PCT/SE2013/050166

§ 371 Date: Aug. 26, 2015

(51) Int. Cl. H04W 76/06

(52) U.S. Cl. CPC H04W 76/068; H04W 84/042

(57) ABSTRACT

In a radio system methods and devices for setting a timer for releasing a common Enhanced Dedicated Channel resource is provided. The methods and devices sets a variable expiration time for the timer so that the expiration time is set in response to a current system load and or in response to the traffic type generated and transmitted in the radio network.

### TECHNICAL FIELD

The present disclosure relates to methods and devices for managing a cellular radio network.

### BACKGROUND

Mobile Communication in cellular radio networks is standardized by the Third Generation Partnership Project (3GPP). In the 3GPP standardization for Wideband Code Division Multiple Access (WCDMA) Release 11 (Rel-11), the work item “Further Enhancements to CELL_FACH” (RP-110436) is ongoing to improve the end user experiences and performance when a User equipment (UE) is in a CELL_FACH state. The work item is focused on resource utilization, throughput, latency and coverage. The detailed working proposals cover the downlink (DL) improvements, uplink (UL) improvements, User Equipment (UE) battery life improvements, and also signaling reduction.

Since CELL_FACH of Rel 8, the Enhanced Dedicated Channel E-DCH transmission for a UE in CELL_FACH state has been supported. Hence, higher order modulation and Hybrid Automatic repeat request (HARQ) can be applied in the CELL_FACH state. This improves the UL data throughput for a UE in CELL_FACH state significantly. It supports a pool of common E-DCH resources shared between UEs at CELL_FACH state and Idle state. One of the common E-DCH resources can be temporarily assigned to a UE in CELL_FACH state. E-DCH resources are normally managed by a Radio Network Controller (RNC), but common E-DCH resources are managed by a radio base station, NodeB. This is because soft handover is supported for E-DCH transmission at CELL_FACH state and the RNC should therefore not be involved. The configuration information of the common E-DCH resources is broadcasted to UEs in the cell.

The procedure to obtain common E-DCH resources in a CELL_FACH state is the same as in Rel-99 Random Access Channel (RACH) transmission, i.e. by accessing the Physical Random Access Channel (PRACH) channel with a randomly selected code and preamble signature. Then preamble transmission power is ramped until an acknowledgement over an Acquisition Indicator Channel (AICH) is received or the maximum access attempts are reached. The Transmission Time Interval (TTI) allocation and the associated common E-DCH resource are indicated through the acknowledgement over the AICH channel.

In case of Dedicated Traffic Channel/Dedicated Control Channel (DTCH/DCCH) transmission, as soon as the common E-DCH resource is assigned to a UE, the resource will be held until one of below the conditions is satisfied:
1) explicit release command, i.e. the network explicitly sends an order on an Absolute Grant Channel (AGCH) channel,
2) implicit release indication, i.e. release based on the expiration of a timer Tb or Tbhs configured by the network,
3) radio link failure discovery, release of common E-DCH resources when radio link failure is detected at a UE,
4) Radio Resource Channel (RRC) channel status change, i.e. the common E-DCH resource is released when the UE switches to another status.

Even in the case of explicit release, the network typically triggers the release order upon expiration of a timer. This implementation specific timer is denoted AG inactivity timer herein. Timer settings for Tb and Tbhs timers are configured via RRC signaling broadcasted in System Information Block (SIB)5 or SIBS bis. In contrast, the AG inactivity timer is implementation dependent and can be configured in different ways. The Tb timer is responsible for the implicit release of common E-DCH resources allocated for the UL data transmission. The Tbhs timer is responsible for the implicit release of the standalone High Speed Dedicated Physical Control Channel (HS-DPCCH), which is allocated for the DL data transmission. The explicit release order is transmitted on the Enhanced AGCH (E-AGCH) channel attached with UE's E-DCH Radio Network Temporary Identifier (E-RNTI) using an E-RNTI-specific Cyclic Redundancy Check (CRC) attachment. The absolute grant value is then set to ‘INACTIVE’.

The scheduling information (SI) including Total E-DCH Buffer Status (TEBS)=zero is used to notify the radio base station NodeB of the status of the UE buffer when the UE Medium Access Control (MAC) buffer becomes empty. When explicit release is activated, the SI with TEBS=zero shall be triggered immediately whenever the TEBS becomes zero and no higher layer data remains in the MAC layer to be transmitted after the transmission of the MAC-i protocol data unit (PDU) containing the SI with the empty buffer status report. If implicit release is activated, the SI with TEBS=zero shall be triggered once, if the TEBS remains zero and no higher layer data remains in MAC to be transmitted for a period given by the E-DCH transmission continuation back off period. Upon the reception of the SI including TEBS=zero, the NodeB knows that the E-DCH resource has been released if implicit release is activated. If explicit release is applied, the Node B would know that the UE buffer is empty upon the reception of the SI including TEBS=zero and typically wait for expiration of AG inactivity timer before sending out AGCH orders to release the E-DCH resources.

Such a procedure is illustrated in FIG. 1 and FIG. 2, which explain the implicit and explicit release schemes. Thus, FIG. 1 sets out an example of an implicit release where an SI with TEBS=zero is sent from the UE to the radio base station NodeB upon existence of a trigger condition as described above and the expiry of a timer. In FIG. 2 an exemplary explicit release is depicted. Here an SI with TEBS=zero is sent from the UE to the radio base station NodeB upon existence of a trigger condition as described above. The NodeB then responds by sending an indication that an AG timer has expired thereby explicitly releasing the resource.

Both types of release methods that are generally outlined in FIGS. 1 and 2 are believed to work well. There is no significant difference between the implicit and explicit release. One difference is where the implementation complexity is located. The implicit release has higher implementation complexity in the UE, since the UE has to implement the related timers and monitor the buffer status from time to time. However, when there is high system load, explicit release might be slower than implicit release since there might be a long AGCH queue. In reality, the network chooses which type of release to be used, depending on different considerations in different scenarios.

There is a constant desire to improve performance in cellular radio networks.

Hence, there is a need for a method and an apparatus that provide an improved utilization of resources in a cellular radio network, in particular a WCDMA radio network.

### SUMMARY

It is an object of the present invention to provide an improved method and apparatus for improving utilization of resources in a cellular radio network, in particular a WCDMA radio network.

This object and others are obtained by the method and device as set out in the appended claims.

As has been realized by the inventors it is important that the common E-DCH resources are not kept longer than needed to accommodate a large number of UE:s in CELL_FACH state. This implies that the applied timer settings should be as small as possible to quickly release the common E-DCH resource used. On the other hand, the timer setting should not be so short that it will release the common E-DCH resource when there is a high probability of new transmissions within a short time period.

Thus, if common E-DCH resources are kept too short, it will cause excessive repeated RACH accesses resulting in an increased UL noise rise and reduced user experience due to longer transmission delays. On the other hand, if the common E-DCH resources are kept too long, it will cause resource starvation (blocking) of the limited common E-DCH resources.

As has further been realized by the inventors, the cell specific and almost static timer settings used are unsuitable for some UEs in the system. In other words the settings for the inactivity timers Tb, Tbhs or AG inactivity timer can be improved. Existing timer settings do not reflect the system load variation. The settings which fit lower system loads are clearly not useful when the system load is high. A finer granularity of timer settings based on the system load and traffic knowledge would therefore improve the performance in the radio network. In existing implementations the network is forced to choose one value to fit all traffic patterns.

To improve performance the timer settings of resource release for common E-DCH resources used in CELL_FACH state is made adjustable. The adjustable timer settings of resource release for common E-DCH resources tuning can also be performed for common E-DCH resources used in Idle state. The adjustment is performed by setting a variable expiration time for the respective timers where the expiration time is set in response to a current system load and or in response to the traffic pattern generated in the transmitter. In accordance with some embodiments the expiration time of a timer is set to a longer time when the system load is determined to be low so that the data to be transmitted can be well captured.

In accordance with some embodiments the expiration time of a timer is set to a shorter time when the system load is determined to be high. The short timer setting would be set when the system is highly loaded so that the utilization of common E-DCH resources can be improved. The system load can be measured by RACH load, UL noise rise or occupation status of the common E-DCH resources, or UL DPCCH SIR target, and DL load (cell power and code) etc.

The expiration time of a timer can be set on a cell level considering the cell load and the knowledge for the dominating traffic type in the cell. The expiration time of a timer can also be set per UE considering the cell load and knowledge of the traffic pattern for the particular UE.

For a UE, knowledge of the traffic pattern can be learned from measurement of historical data, from real-time machine learning or from an analysis of the RRC signaling or from other schemes like deep packet inspection (DPI) etc. With knowledge of the traffic pattern for a UE, the timer settings can be set based to the traffic type of the UE.

The timer setting can be further adjusted based on a prediction of upcoming data transmissions/receptions. If a predicted data arrival is after a predefined threshold, the timer setting can be set as 0, so that the common E-DCH resource will be released immediately.

Traffic priority knowledge can also be used for timer setting so that the common E-DCH resources allocated for lower priority traffic types would be released quickly for the higher priority traffic when the system is highly loaded. Also traffic types which are relatively delay sensitive traffic can be set with a relatively long timer. Vice versa, traffic which is relatively non sensitive to delay could be set with a relatively short timer.

The disclosure also extends to a device for use in a cellular radio system adapted to perform the methods as described herein. The device can be provided with a controller/controller circuitry for performing the above processes. The controller(s) can be implemented using suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor or may include, without limitation, digital signal processor (DSP) hardware, ASIC hardware, read only memory (ROM), random access memory (RAM), and/or other storage media.

### BRIEF DESCRIPTION OF THE DRAWINGS

The present invention will now be described in more detail by way of non-limiting examples and with reference to the accompanying drawings, in which:

FIGS. 1 and 2 illustrate implicit and explicit release schemes,

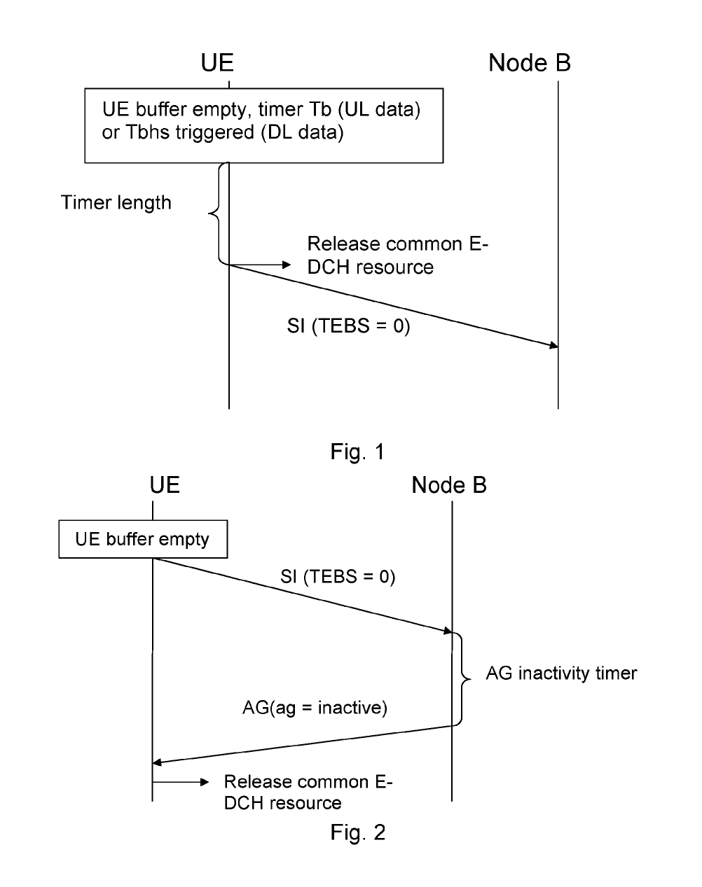

FIG. 3 is a general view of a cellular radio network,

FIGS. 4 and 5 illustrate release of a common E-DCH resource,

FIG. 6 is a flow chart illustrating some steps performed when setting timers in a cellular radio network,

FIG. 7 illustrate timer settings in response to system load,

FIG. 8 depicts an exemplary data base set-up, and

FIG. 9 depicts a network node for setting release timers.

### DETAILED DESCRIPTION

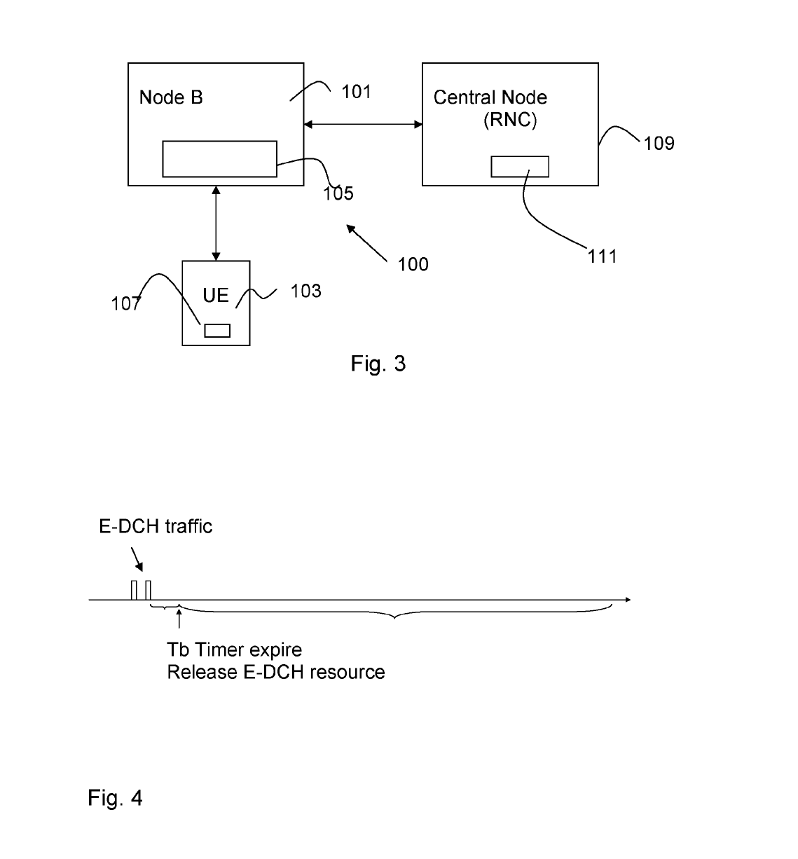

In FIG. 3 a general view of a cellular radio network 100 is depicted. The network 100 can for example be a WCDMA system. The network 100 comprises a number of radio base stations 101, here denoted NodeBs, whereof only one is shown in the simplified view in FIG. 3. The radio base stations 101 are connected to a control node denoted Radio Network controller (RNC) 109. The network 100 may of course comprise multiple RNCs. The RNC 109 further comprises a module 111 for performing different operations of the radio base station 109. Mobile stations 103, here represented by a single unit and denoted User Equipment (UE), that are present in a geographical area covered by the radio base station can connect to the radio base station over an air-interface. The radio base station 101 further comprises a module 105 for performing different operations of the radio base station 101. The module 105 can for example be implemented using a microcontroller operating on a set of computer software instructions stored on a memory in the module 105. The UEs 103 in turn comprises a module 107 adapted to perform operations of the UEs 103. The module 107 can for example be implemented using a microcontroller operating on a set of computer software instructions stored on a memory in the module 107. The NodeB supports transmission to and from the UEs in the area that it covers.

The UEs 103 can be in different states one of which is CELL_FACH state as set out above. The UEs can also be in Idle state. In order to improve the performance in the system it is desired that the common E-DCH resources used when a UE is in CELL_FACH state are not kept longer than needed to accommodate a large number of UE:s in CELL_FACH state, implying that the applied timer settings should be as small as possible to quickly release the E-DCH resource used. On the other hand, the timer setting should not be so short that it will release the E-DCH resource when there is a high probability of new transmissions within the near future.

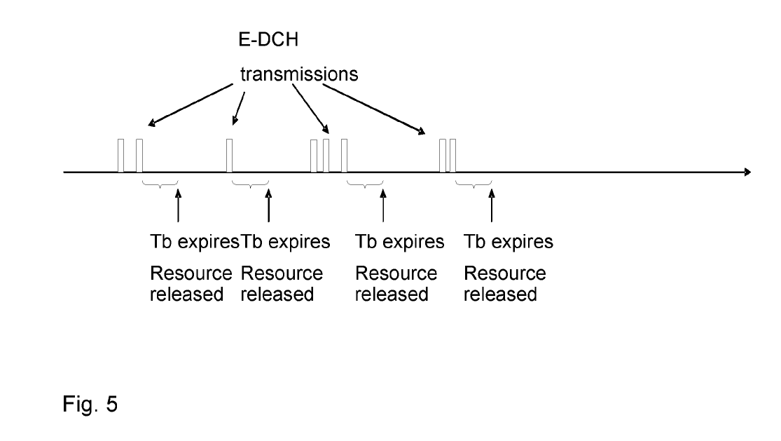

An illustration of a desired behavior is depicted in FIG. 4. Here the common E-DCH resource is released very quickly when the user has no more data for a long time due to a short expiration time set for the Tb timer resulting in efficient common E-DCH resource utilization.

An example of undesirable behavior is depicted in FIG. 5. Here the traffic pattern is different with repeated bursts of data. The user is forced to do repeated accesses due to its traffic pattern and the time set for the Tb timer. The timer setting is too short to handle the traffic pattern efficiently for this user. This results in repeated RACH accesses and increased Up Link (UL) noise rise. Further, unnecessary delay is caused for the data transmission.

Hence, the need for different timer settings in a cell can depend on several factors. As described above, the traffic pattern may be different for different users. Some users use applications which cause very long chatty sessions while others do not.

Also, the system load can impact what timer settings that should be used. Thus, in low load situations, it is possible to give all users relatively long timer settings without having a large blocking probability. In cases with higher load, the majority of users may need to have short settings, although it can still be possible to give long expiration times to some users.

There may also be procedures which would benefit from longer timer settings. An example is Cell_FACH improvements for so called Hetnets, i.e. heterogeneous networks connecting computers and other devices with different operating systems and/or protocols. These solutions may require that these users keep their common E-DCH resources longer than other users.

As set out above, in existing systems the timer settings for the Tb timer or Tbhs timer are configured by broadcasting signaling. Hence, both the Tb and Tbhs timers are set with cell specific settings. The AG inactivity timer is typically also set with a cell specific setting although it is implementation dependent. In view of the above it is clear that cell specific and almost static timer (timer Tb, Tbhs or AG inactivity timer) settings are typically unsuitable for some UEs in the system. Further, the timer settings do not reflect the system load variation. The timer settings which fit lower system loads are clearly not useful when the system load is high. A finer granularity of timer settings based on the system load and traffic knowledge would therefore improve the performance in the cellular radio network.

In accordance with some embodiments the timer settings of resource release for common E-DCH resources are tuned when a UE is in CELL_FACH or Idle state. The tuning is performed in response to some preset parameter. The parameters can for example be system load and traffic type. In accordance with some embodiments a longer timer setting is set when the system load is low, e.g. below a predefined threshold value, so that upcoming data can be well captured. Similarly, a short timer setting can be set when the system given a high load, e.g. above some predefined threshold value, so that the utilization of common E-DCH resources can be improved. The system load can for example be defined as the RACH load, UL noise rise or occupation status of the common E-DCH resources, or UL DPCCH SIR target, and DL load (cell power and code) or some other suitable measure that can be used to determine the current load in the system. The timer settings can be tuned on a cell level considering the cell load and the knowledge for the dominating traffic type in the cell. The timer setting tuning can also be carried out for an individual UE considering the cell load and the knowledge of the traffic pattern for a particular UE.

For a UE, knowledge of the traffic pattern can be learned from measurement of historical data, from real-time machine learning or from the analyses of the RRC signaling or from other schemes like deep packet inspection (DPI) etc. With the knowledge of the traffic pattern for a particular UE, the timer settings can be adapted to the traffic type of the individual UE.

The timer setting can be further tuned using a prediction of upcoming data activities as an input parameter. If the predicted data arrival is after a predefined threshold, the timer setting can be set as 0, so the common E-DCH resource will be released immediately. Traffic priority knowledge can also be used for tuning the timer settings. For example, common E-DCH resources allocated for lower priority traffic types can be released quickly for higher priority traffic when the system is highly loaded. Also traffic types which are relatively delay sensitive traffic can be set with a relatively long timer. Vice versa, traffic which is relatively non sensitive to delay can be set with a relatively short timer.

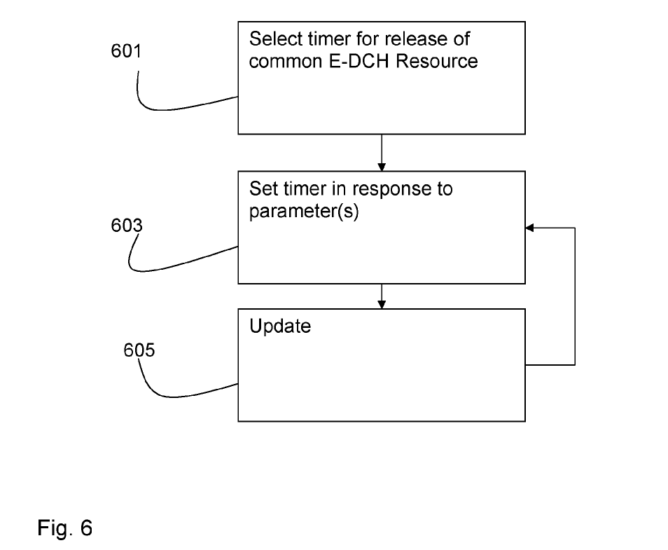

In FIG. 6 a flow chart illustrating some steps performed when setting timers in a cellular radio network are shown. It is assumed that the timer is started (or re-started) when there is an E-DCH transmission or DL data. The timer runs until it is either re-started or until it expires. It expires when it has run for a time period which is equal to the timer setting, i.e the expiration time. First in a step 601 it is determined to set a timer for releasing a common E-DCH resource in the cellular radio network. The timer can typically be a Tb timer or a Tbhs timer. The timer can also be an AG inactivity timer, i.e. an implementation specific timer. The expiration of the timer is then set in response to at least one parameter in a step 603. The parameter can typically be a determined current system load and or a determined traffic type generated and transmitted in the radio network or a combination thereof. The timer can then in a step 605 be dynamically updated in response to variations in the parameter(s) applied in step 603. The update can take place based on changes in the parameter values; or be performed on a periodic basis so that the timer expiration is adjusted with some given periodicity.

### Determination of System Load

The system load can be measured in terms of the RACH load, noise rise, and occupation of the common E-DCH resources, or even the DL cell load, for example in terms of power or code utilization. The RACH load can for example be measured in the blocking probability for Release 8 (R8) and later releases of UE access requests, or the responding delay of access requests for R8 and later releases UE, or the noise rise generated by RACH transmission. The overall noise rise can also be used to reflect the cell load situation, i.e. the system load. The noise rise can be attributed to both CELL_FACH UEs and CELL_DCH UEs. The UL DPCCH SIR target is another possible metric that can be used for UL load estimation and hence used to determine the system load. The occupation of the common E-DCH resource can be measured by counting the number of the occupied common E-DCH resources.

Regardless how the system load is determined it can be advantageous to continuously update the determined system load to ensure that changes in the load are captured in the settings of the timers discussed above.

### Determination of Traffic Pattern

### Learning Based on Historic Data

For DCCH/DTCH data, when the UE has completed power ramping and sends its first data on E-DCH, the UEs E-DCH Radio Network Temporary Identifier (E-RNTI) is attached to the medium Access Control-i (MAC-i) header for the identification of UE by Node B. The Node B can use this UE identification to look up a determined traffic pattern for the particular UE. The UE traffic pattern for each UE can for example be stored in a data base. For a specific UE, it is typically most probable that this UE has similar traffic pattern during the same time period every day. Since the Node B only holds history for its own cell this database is limited. As an alternative, the procedure can be executed by the RNC, i.e. the database is stored by the RNC and the RNC is configured to determine a traffic type for a particular UE at a given time. The historical data can be measured and analyzed on a cell or system level over a larger area. Hence, the dominating traffic type at a given time can be learned. The timer settings are then set using the determined traffic pattern for a UE as an input parameter

### Real-Time Machine Learning

A release time can be estimated during the current access. This can be implemented such that after reception or transmission of data, the time until the next transmission/reception is predictable. After each transmission or reception the procedure is repeated. The prediction algorithm can be learned based on historical data. The prediction algorithm can be combined with DPI (deep packet inspection) techniques. This will make it possible to distinguish RRC signaling from data and also identify different applications, and hence predict the time to the next transmission. The predicted data activity information is then used as traffic pattern input by the network to determine the timer settings. RRC signaling have predictable transmission patterns and release timers for a certain RACH access/common E-DCH can be tuned based on RRC/non-RRC transmissions as a traffic type parameter. Different timer settings than the data Radio bearers (RBs) can be applied for Signaling Radio Bearers (SRBs) e.g. SRBs1-4.

Further, DPI schemes can be used to identify applications and timers can be set in response to a traffic pattern parameter determined based on a DPI scheme identifying a particular application.

Below some exemplary implementations in a cellular radio network are described in more detail.

### Embodiment 1

### Timer Settings in Response to System Load

Timer setting is performed based on the estimated system load.
1. The system load for example, RACH load, UL noise, occupation of the common E-DCH resources, UL DPCCH SIR target and DL load (cell power and code utilization) is monitored. The monitoring can be performed periodically.
2. A relatively long time is set for the timer when the system has low load. For example if the load is determined to be below a threshold value the timer is set to a long time, e.g. 600 ms.
3. A relatively short timer is set for the timer when the system has high load. For example if the load is determined to be above a threshold value the timer is set to a short time, e.g. 10 ms.

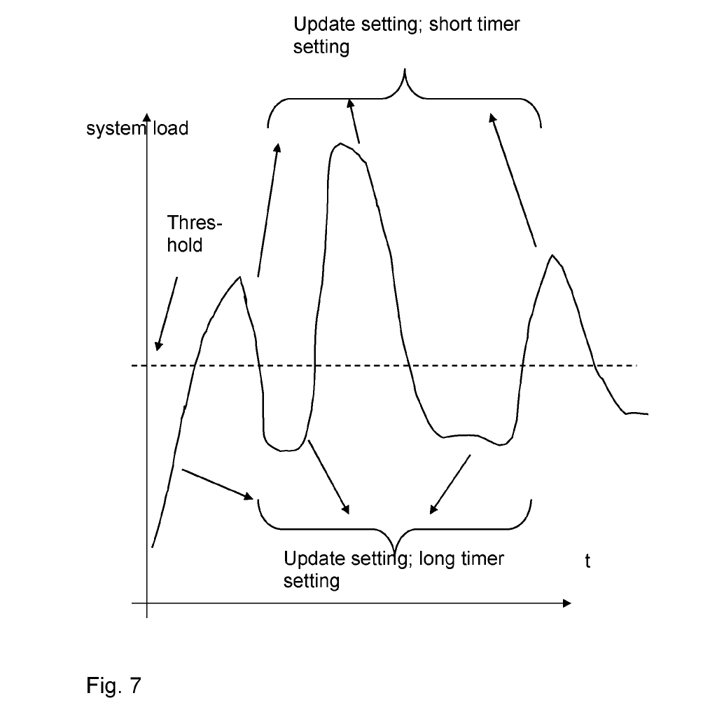

In FIG. 7, a scenario where the above scheme is used is depicted.

In case of explicit release, the release time can be adjusted almost continuously. However, this requires that the load monitoring is carried out in a continuous fashion.

In case of implicit release, the release time is implemented by the values configured for the E-DCH continuation back-off (Tb timer) and Node B triggered HS-DPCCH continuation back-off (Tbhs timer) settings will typically not be tuned too often. This also puts lower requirements on the load monitoring.

### Embodiment 2a

### Timer Setting Based on Traffic Pattern I

In this embodiment the timer setting is set in accordance with a traffic pattern. A traffic pattern for example Cumulative Distribution Functions (CDFs) of inter-arrival times, cell id and preferred release timer settings are estimated and stored for a UE in a data base. The preferred release timer settings can for example be the 95^{th} percentile of the inter-arrival times or settings which would aggregate traffic to bursts. For example for the scenario depicted in FIG. 5 a timer setting which would keep the common E-DCH resource for all the traffic can be a preferred release timer setting. The database can be updated after that a UE has been in the Cell_FACH state. Furthermore, the traffic pattern and preferred timer settings can be derived separately for UL triggered and DL triggered accesses.

The setting of the timer(s) can as an alternative be performed on a cell level if a timer setting for an individual UEs is not possible. In case timer settings is performed on a cell level, the Node B or RNC can be configured to determine the dominating traffic type in a specific cell. The dominating traffic type can be determined based on the data volume which is generated, the total resource consumption or some other suitable metric. Timer settings are then applied to the whole cell.

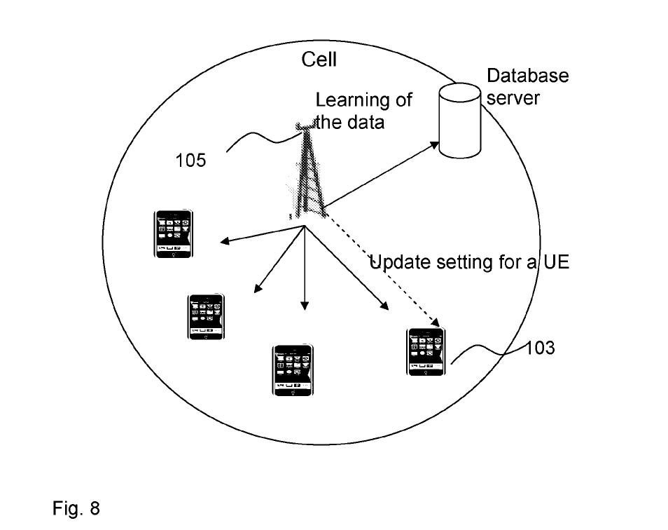

How the database is used depends on if explicit or implicit release is used. FIG. 8, depicts an exemplary data base set-up that can be used in the following examples.

### Explicit Release

When a UE obtains a new common E-DCH resource, the Node B looks up the preferred timer setting from the database and configures this timer setting for the explicit release for the UE, taking the current cell load into account.

### Implicit Release

In case of implicit release, the timer setting can only be used in the entire cell. This means that the traffic characteristics for a specific cell must be combined with the preferred timer settings for the UEs that generate data traffic in this cell. The Tb and Tbhs are updated accordingly taking the current cell load into account.

### Embodiment 2b

### Timer Setting Based on Traffic Pattern II

The timer setting can in accordance with another embodiment be set based on a prediction of the data activities for a UE. For prediction of UE data transmission/reception, the time of the next data transmission or reception is predicted. In accordance with some embodiments if the predicted time is larger than a predetermined time threshold, it is determined to be unnecessary to keep the common E-DCH resource. Instead, the resource is released immediately. In other implementations, the E-DCH release timer is set equal to e.g. the time threshold. If new data is transmitted or received before the timer has expired, the prediction is repeated and a new action is taken, i.e. the common E-DCH resource is released or the timer is set.

Other information can be used as input to the prediction algorithm to further improve the prediction accuracy. For example, in case the prediction is carried out for SRBs, the RRC message exchange order can be considered. Hence, if a RRC Reconfiguration message in DL is recognized, the Radio Link Control (RLC) status report for acknowledgement and the Reconfiguration Confirm message would be expected in UL. Other information for example, knowledge of Transmission Control Protocol (TCP) transmission if the traffic is TCP based, or knowledge of Voice over IP (VoIP) traffic pattern can also be used as information input to the prediction algorithms.

The predetermined time threshold is typically set to balance good end user performance and efficient resource utilization. For the prediction, the threshold value can be set taking into account the current load in the system. Hence, the threshold value is advantageously updated over time to reflect the current system load.

### Signaling of the Timer Setting

It is typically a network node that determines the suitable timer settings for a cell level or for an individual UE. A new timer setting is notified to the UEs by signaling. This can for example be performed via broadcasting, such as system information block (SIB) broadcasting signaling or dedicated signaling, such as RRC signaling. The notification of a new timer setting is also possible to signal by using other alternatives, for example, a new timer setting can be carried in the extension of any DL Layer 1/Layer 2 (L1/L2) channels including control channels High Speed-Shared Control Channel (HS-SCCH), E-DCH Absolute Grant Channel (E-AGCH), E-DCH Relative Grant Channel (E-RGCH). In another alternative embodiment the notification of a new timer setting is attached in DL data packets as in-band signaling messages.

To reduce the signaling overhead, a UE centric configuration can be used. In such an embodiment the network node such as the Node B is configured to propose a few typical standard timer settings corresponding to different system load or different traffic patterns.

The UE is then configured to set the timer setting to any one of the standard timer settings in response to the situation at hand. When the common E-DCH resource is released, the UE can be configured to report this to the Node B. The report of a released common E-DCH resource can be done by transmitting Scheduling Information/System Information (SI) with Total E-DCH Buffer Status=0 (TEBS=0) to Node B.

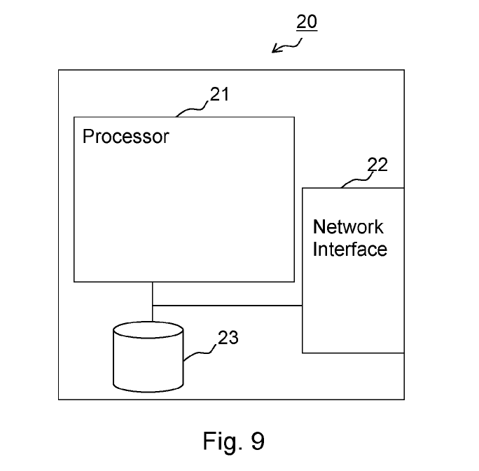

FIG. 9 illustrate a device for setting release timers for release of a common E-DCH resource. The device is implemented in a central node 20. The central node 20 can be implemented as a stand alone server or it can be embedded in an existing node such as a NodeB or an RNC. The central node comprises controller circuitry such as a processor 21, a memory 23, and also a network interface 22 for connection to other nodes of the network that the central node is in communication with. In particular embodiments, the methods for setting the release timers described is provided by the processor 21 executing instructions stored on a computer-readable medium, such as the memory 23. The hardware of the central node 20 can comprise one or many processors 21 that can be arranged to execute software stored in a readable storage media such as the memory 23. The processor(s) can be implemented by a single dedicated processor, by a single shared processor, or by a plurality of individual processors, some of which may be shared or distributed. Moreover, a processor or may include, without limitation, digital signal processor (DSP) hardware, ASIC hardware, read only memory (ROM), random access memory (RAM), and/or other storage media.

Using the methods and devices as described herein can allow the network to improve the release timer settings to allow a more efficient use of the common E-DCH resources. In case of explicit release, the setting adjustment can be done per UE. Adjustment of release timer settings will be beneficial to UE performance in that it allows for reduced delays and also a balance of the resource occupation.

In the above it is set out that timer setting per UE is only applicable when the explicit release is activated, i.e. to set the AG inactivity timer on a user level, while the cell/system level tuning is applicable when the implicit release is activated. However, for future releases, it is envisaged that an explicit release and implicit release exist concurrently in the same cell, or the different timer settings (Tb or Tbhs) can be defined for different users. In that case, the cell level tuning and user level tuning can be combined together.

1. A method of setting a timer for releasing a common Enhanced Dedicated Channel, E-DCH, resource in a cellular radio network, the method comprising setting a variable expiration time for the timer wherein the expiration time is set in response to a current system load and or in response to a traffic pattern generated and transmitted in the radio network.

2. The method according to claim 1, further comprising updating the variable expiration time.

3. The method according to claim 2 wherein the updating is performed continuously or periodically.

4. The method according to claim 1, wherein the timer is applied for a User Equipment, UE, in CELL_FACH state or in Idle state.

5. The method according to claim 1, wherein the timer is a Tb timer, a Tbhs timer or an implementation specific timer.

6. The method according to claim 1, wherein when the system load is determined to be below a threshold value the timer is set to a long time.

7. The method according to claim 1, wherein when the system load is determined to be above a threshold value the timer is set to a short time.

8. The method according to claim 1, wherein the system load is measured as Random Access Channel, RACH or load, noise rise or occupation of the common E-DCH resources, or downlink cell load.

9. The method according to claim 1, wherein the expiration time is set based on an observed or a predicted traffic pattern.

10. The method according to claim 1, wherein the variable expiration time is signaled to a UE.

11. The method according to claim 10, wherein the signaled variable expiration time is broadcasted to all UEs in a cell.

12. The method according to claim 10, wherein the signaled variable expiration time is transmitted to a UE via dedicated signaling.

13. The method according to claim 1, wherein the traffic pattern is determined based on measurement of historical data or based on real-time machine learning or based the Radio Resource Control, RRC, signaling.

14. A network node for setting a timer for releasing a common Enhanced Dedicated Channel, E-DCH, resource in a cellular radio network, the network node comprising controller circuitry adapted to set a variable expiration time for the timer, the expiration time being set in response to a current system load and or in response to a traffic pattern generated and transmitted in the radio network.

15. The network node according to claim 14, wherein the network node is configured to update the variable expiration time.

16. The network node according to claim 15, wherein the network node is configured to perform the update continuously or periodically.

17. The network node according to claim 14, where the timer is applied for a User Equipment, UE, in CELL_FACH state or in Idle state.

18. The network node according to claim 14, where the timer is a Tb timer, a Tbhs timer or an implementation specific timer.

19. The network node according to claim 14, wherein the network node is configured to set the timer to a long time when the system load is determined to be below a threshold value.

20. The network node according to claim 14, wherein the network node is configured to set the timer to a short time when the system load is determined to be above a threshold value.

21. The network node according to claim 14, where the system load is measured as Random Access Channel, RACH or load, noise rise or occupation of the common E-DCH resources, or downlink cell load.

22. The network node according to claim 14, wherein the network node is configured to set the expiration time based on an observed or a predicted traffic pattern.

23. The network node according to claim 14, wherein the network node is configured to signal the variable expiration time to a UE.

24. The network node according to claim 23, wherein the network node is configured to broadcast the variable expiration time to all UEs in a cell.

25. The network node according to claim 23, wherein the network node is configured to signal the variable expiration time to a UE via dedicated signaling.

26. The network node according to claim 14, wherein the network node is configured to determine the traffic pattern based on measurement of historical data or based on real-time machine learning or based the Radio Resource Control, RRC, signaling.
